(19) United States
(12) Patent Application Publication
(10) Pub. No.: US 2026/0023604 A1
(43) Pub. Date: Jan. 22, 2026

(54) DYNAMIC BYTE CONFIGURATION FOR COMPUTATIONAL PROGRAM INTERPRETATION

(71) Applicant: SK Hynix NAND Product Solutions Corp. (dba Solidigm), Rancho Cordova, CA (US)

(72) Inventor: Vincent LAZO, San Dimas, CA (US)

(21) Appl. No.: 18/779,515

(22) Filed: Jul. 22, 2024

(51) Int. Cl. G06F 21/78; G06F 13/16; G06F 21/64

(52) U.S. Cl. CPC G06F 9/5016; G06F 9/4843; G06F 13/1673; G06F 2209/5017

(57) ABSTRACT

This application is directed to data processing in an electronic device that includes a processing unit and a non-volatile memory (e.g., NAND flash memory). The electronic device obtains a block of structured data having a block header and one or more data segments that includes at least a first data segment associated with a first program. The block header of the block of structured data to determine segment metadata of the first data segment. The electronic device extracts the first data segment from the block of structured data based on the segment metadata, and executes the first program based on the first data segment. An example of the electronic device is a memory device having a computational capability. Each data segment may include one more of an executable program, an instruction to execute the executable program, machine learning parameters, security information, and a firmware flow.

### TECHNICAL FIELD

This application relates generally to resource management in a memory system including, but not limited to, methods, systems, and non-transitory computer-readable media for managing a data structure and facilitating data processing capabilities on an electronic device (e.g., a memory device).

### BACKGROUND

Memory is applied in a computer system to store instructions and data. The data are processed by one or more processors of the computer system according to the instructions stored in the memory. Multiple memory units are used in different portions of the computer system to serve different functions. Specifically, the computer system includes non-volatile memory that acts as secondary memory to keep data stored thereon if the computer system is decoupled from a power source. Examples of the secondary memory include, but are not limited to, hard disk drives (HDDs) and solid-state drives (SSDs). The secondary memory relies on a memory controller to manage its memory space and process read, write, and read-modify-write requests from a host device efficiently with low latency.

### SUMMARY

Various embodiments of this application are directed to methods, systems, devices, non-transitory computer-readable media for loading executable and/or nonexecutable data to an electronic device (e.g., a memory device) in a structured manner. In some embodiments, the memory device is transformed to a computational storage device (CSD) by incorporating a data processor. The data processor is configured to process internal computational workloads (e.g., the data processing operations) locally on the memory device, while a memory controller of the memory device specializes in performing memory access functions and internal memory management functions. In accordance with at least some embodiments disclosed herein is the realization that computational and communication resources of an electronic device are not efficiently utilized if executable and/or nonexecutable data associated with each individual program are separately loaded on a CSD. In some implementations, a host device organizes separate customer components (e.g., executable programs, non-executable byte segments) into a block of structured data according to a script. The block of structured data is provided to a firmware of the CSD, which loads the block of structured data onto a processor unit (e.g., the data processor) of the CSD. When an instruction is received from the host device or when a predefined trigger condition is satisfied, a segment of the block of structured data is extracted and used by a corresponding program. As such, in some embodiments, the block of structured data is loaded in an electronic data (e.g., the CSD) with a computational program header, dynamic fields, and function indicators, and a dynamic byte configuration is applied to interpret computational programs associated with the block of structured data in the electronic device.

In one aspect, a method is implemented at an electronic device to load structured data. The electronic device includes a processor unit and a non-volatile memory. The method includes obtaining a block of structured data having a block header and one or more data segments that includes at least a first data segment associated with a first program, processing the block header of the block of structured data to determine segment metadata of the first data segment, extracting the first data segment from the block of structured data based on the segment metadata, and executing the first program based on the first data segment. In some embodiments, the block header includes a plurality of data fields. The plurality of data fields include one or more of: a total size of the block of structured data, a size of the block header, a data validity hash, and segment metadata of the one or more data segments. The segment metadata of each data segment include one or more of: a segment identifier, a segment header flag indicating whether the respective data segment includes a respective segment header, a location and a size of the respective segment header, a segment type, description, a usage plan, security data, a credential signature, and version control data of the respective data segment.

In some embodiments, the method further includes, at the host device, obtaining a script of the block of structured data and generating the block of structured data according to the script. The block header includes a plurality of data fields that are organized according to the script, and the segment metadata of the first data segment corresponds to a subset of data fields.

In another aspect, some implementations include an electronic device that includes a processing unit, a non-volatile memory coupled to the processing unit, and memory having instructions stored thereon for performing any of the above methods of processing data (specifically, loading structured data). In some embodiments, the electronic device is a memory system (e.g., SSDs) or a memory device (e.g., an SSD), and the processing unit includes a memory controller, a data processor distinct from the memory controller, or a combination thereof.

In yet another aspect, some implementations include a non-transitory computer readable storage medium storing one or more programs. The one or more programs include instructions, which when executed by an electronic device cause the electronic device to implement any of the above methods of processing data (specifically, loading structured data).

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is a block diagram of an example system module in a typical electronic device in accordance with some embodiments.

FIG. 2 is a block diagram of a memory system of an example electronic device having one or more memory access queues, in accordance with some embodiments.

FIG. 3 is a block diagram of an example computer system that includes a memory system having an internal processing capability, in accordance with some embodiments.

FIG. 4 is a block diagram of an example computer system including a memory system that operates in compliance with a storage access and transport protocol, in accordance with some embodiments.

FIG. 5 is a block diagram of an example computer system that is loaded with a block of structured data, in accordance with some embodiments.

FIG. 6 is a structural diagram of an example block header of a block of structured data loaded in an electronic device (e.g., a memory device), in accordance with some embodiments.

FIG. 7 is a structural diagram of an example data segment in a block of structural data loaded in an electronic device (e.g., a memory device), in accordance with some embodiments.

FIG. 8 is a flow diagram of an example method for managing a data structure, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with storage capabilities.

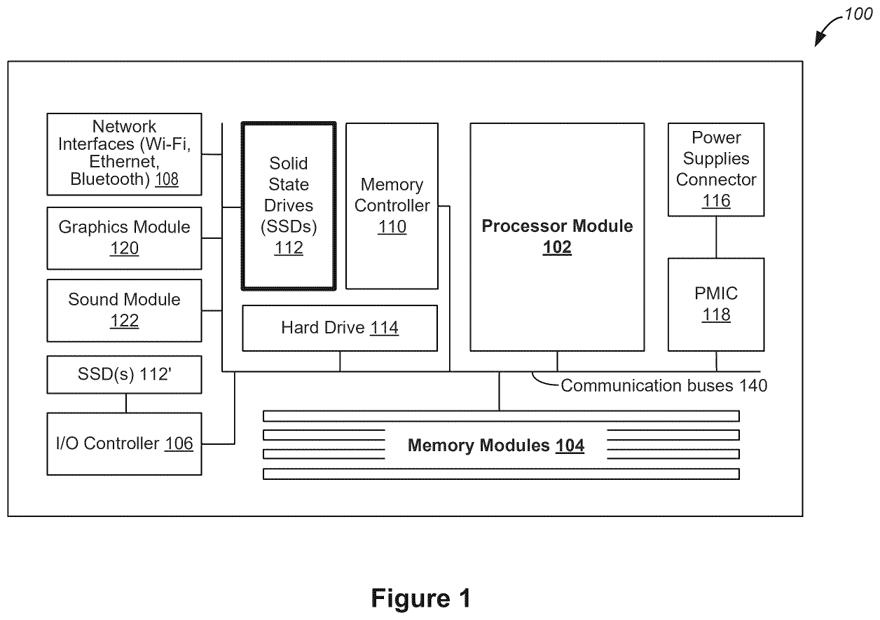

FIG. 1 is a block diagram of an example system module 100 in a typical electronic system in accordance with some embodiments. The system module 100 in this electronic system includes at least a processor module 102, memory modules 104 for storing programs, instructions and data, an input/output (I/O) controller 106, one or more communication interfaces such as network interfaces 108, and one or more communication buses 140 for interconnecting these components. In some embodiments, the I/O controller 106 allows the processor module 102 to communicate with an I/O device (e.g., a keyboard, a mouse or a trackpad) via a universal serial bus interface. In some embodiments, the network interfaces 108 includes one or more interfaces for Wi-Fi, Ethernet and Bluetooth networks, each allowing the electronic system to exchange data with an external source, e.g., a server or another electronic system. In some embodiments, the communication buses 140 include circuitry (sometimes called a chipset) that interconnects and controls communications among various system components included in system module 100.

In some embodiments, the memory modules 104 include high-speed random-access memory, such as static random-access memory (SRAM), double data rate (DDR) dynamic random-access memory (DRAM), or other random-access solid state memory devices. In some embodiments, the memory modules 104 include non-volatile memory, such as one or more magnetic disk storage devices, optical disk storage devices, flash memory devices, or other non-volatile solid state storage devices. In some embodiments, the memory modules 104, or alternatively the non-volatile memory device(s) within the memory modules 104, include a non-transitory computer readable storage medium. In some embodiments, memory slots are reserved on the system module 100 for receiving the memory modules 104. Once inserted into the memory slots, the memory modules 104 are integrated into the system module 100.

In some embodiments, the system module 100 further includes one or more components selected from a memory controller 110, SSD(s) 112, an HDD 114, power management integrated circuit (PMIC) 118, a graphics module 120, and a sound module 122. The memory controller 110 is configured to control communication between the processor module 102 and memory components, including the memory modules 104, in the electronic system. The SSD(s) 112 are configured to apply integrated circuit assemblies to store data in the electronic system, and in many embodiments, are based on NAND or NOR memory configurations. The HDD 114 is a conventional data storage device used for storing and retrieving digital information based on electromechanical magnetic disks. The power supply connector 116 is electrically coupled to receive an external power supply. The PMIC 118 is configured to modulate the received external power supply to other desired DC voltage levels, e.g., 5V, 3.3V or 1.8V, as required by various components or circuits (e.g., the processor module 102) within the electronic system. The graphics module 120 is configured to generate a feed of output images to one or more display devices according to their desirable image/video formats. The sound module 122 is configured to facilitate the input and output of audio signals to and from the electronic system under control of computer programs.

Alternatively or additionally, in some embodiments, the system module 100 further includes SSD(s) 112′ coupled to the I/O controller 106 directly. Conversely, the SSDs 112 are coupled to the communication buses 140. In an example, the communication buses 140 operates in compliance with Peripheral Component Interconnect Express (PCIe or PCI-E), which is a serial expansion bus standard for interconnecting the processor module 102 to, and controlling, one or more peripheral devices and various system components including components 110-122.

Further, one skilled in the art knows that other non-transitory computer readable storage media can be used, as new data storage technologies are developed for storing information in the non-transitory computer readable storage media in the memory modules 104, SSD(s) 112 or 112′, and HDD 114. These new non-transitory computer readable storage media include, but are not limited to, those manufactured from biological materials, nanowires, carbon nanotubes and individual molecules, even though the respective data storage technologies are currently under development and yet to be commercialized.

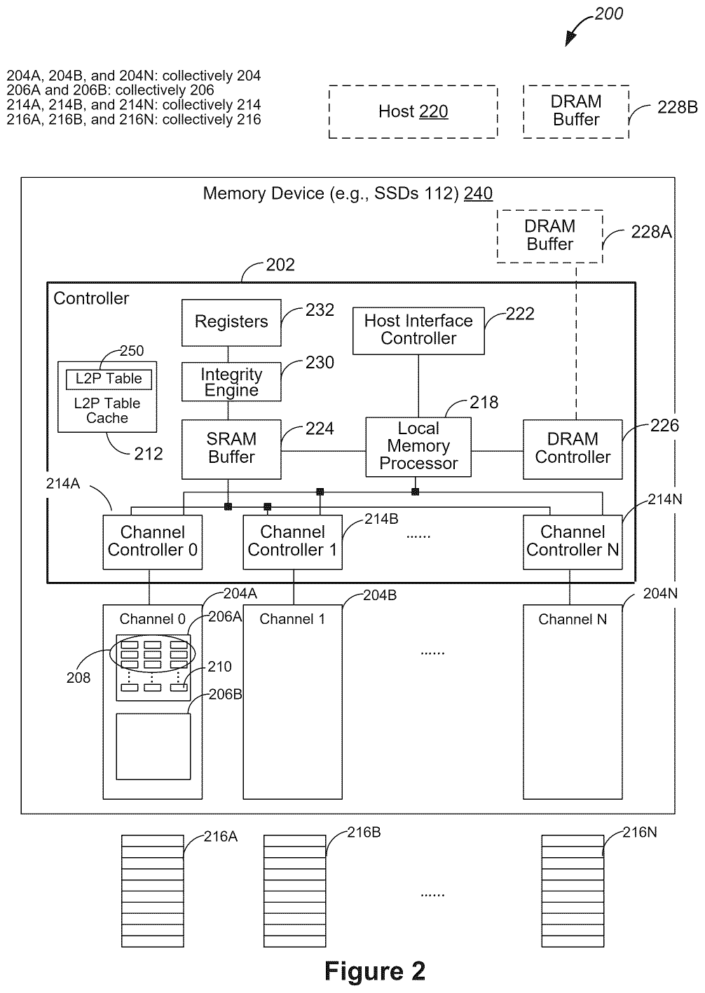

FIG. 2 is a block diagram of a memory system 200 of an example electronic device having one or more memory access queues, in accordance with some embodiments. The memory system 200 is coupled to a host device 220 (e.g., a processor module 102 in FIG. 1) and configured to store instructions and data for an extended time, e.g., when the electronic device sleeps, hibernates, or is shut down. The host device 220 is configured to access the instructions and data stored in the memory system 200 and process the instructions and data to run an operating system and execute user applications. The memory system 200 includes one or more memory devices 240 (e.g., SSD(s)). Each memory device 240 further includes a controller 202 and a plurality of memory channels 204 (e.g., channel 204A, 204B, and 204N). Each memory channel 204 includes a plurality of memory cells. The controller 202 is configured to execute firmware level software to bridge the plurality of memory channels 204 to the host device 220. In some embodiments, each memory device 240 is formed on a printed circuit board (PCB).

Each memory channel 204 includes on one or more memory packages 206 (e.g., two memory dies). In an example, each memory package 206 (e.g., memory package 206A or 206B) corresponds to a memory die. Each memory package 206 includes a plurality of memory planes 208, and each memory plane 208 further includes a plurality of memory pages 210. Each memory page 210 includes an ordered set of memory cells, and each memory cell is identified by a respective physical address. In some embodiments, the memory device 240 includes a plurality of superblocks. Each superblock includes a plurality of memory blocks each of which further includes a plurality of memory pages 210. For each superblock, the plurality of memory blocks are configured to be written into and read from the memory system via a memory input/output (I/O) interface concurrently. Optionally, each superblock groups memory cells that are distributed on a plurality of memory planes 208, a plurality of memory channels 204, and a plurality of memory dies 206. In an example, each superblock includes at least one set of memory pages, where each page is distributed on a distinct one of the plurality of memory dies 206, has the same die, plane, block, and page designations, and is accessed via a distinct channel of the distinct memory die 206. In another example, each superblock includes at least one set of memory blocks, where each memory block is distributed on a distinct one of the plurality of memory dies 206 includes a plurality of pages, has the same die, plane, and block designations, and is accessed via a distinct channel of the distinct memory die 206. The memory device 240 stores information of an ordered list of superblocks in a cache of the memory device 240. In some embodiments, the cache is managed by a host driver of the host device 220, and called a host managed cache (HMC).

In some embodiments, the memory device 240 includes a single-level cell (SLC) NAND flash memory chip, and each memory cell stores a single data bit. In some embodiments, the memory device 240 includes a multi-level cell (MLC) NAND flash memory chip, and each memory cell of the MLC NAND flash memory chip stores 2 data bits. In an example, each memory cell of a triple-level cell (TLC) NAND flash memory chip stores 3 data bits. In another example, each memory cell of a quad-level cell (QLC) NAND flash memory chip stores 4 data bits. In yet another example, each memory cell of a penta-level cell (PLC) NAND flash memory chip stores 5 data bits. In some embodiments, each memory cell can store any suitable number of data bits. Compared with the non-SLC NAND flash memory chips (e.g., MLC SSD, TLC SSD, QLC SSD, PLC SSD), the SSD that has SLC NAND flash memory chips operates with a higher speed, a higher reliability, and a longer lifespan, and however, has a lower device density and a higher price.

Each memory channel 204 is coupled to a respective channel controller 214 (e.g., controller 214A, 214B, or 214N) configured to control internal and external requests to access memory cells in the respective memory channel 204. In some embodiments, each memory package 206 (e.g., each memory die) corresponds to a respective queue 216 (e.g., queue 216A, 216B, or 216N) of memory access requests. In some embodiments, each memory channel 204 corresponds to a respective queue 216 of memory access requests. Further, in some embodiments, each memory channel 204 corresponds to a distinct and different queue 216 of memory access requests. In some embodiments, a subset (less than all) of the plurality of memory channels 204 corresponds to a distinct queue 216 of memory access requests. In some embodiments, all of the plurality of memory channels 204 of the memory device 240 corresponds to a single queue 216 of memory access requests. Each memory access request is optionally received internally from the memory device 240 to manage the respective memory channel 204 or externally from the host device 220 to write or read data stored in the respective channel 204. Specifically, each memory access request includes one of: a system write request that is received from the memory device 240 to write to the respective memory channel 204, a system read request that is received from the memory device 240 to read from the respective memory channel 204, a host write request that originates from the host device 220 to write to the respective memory channel 204, and a host read request that is received from the host device 220 to read from the respective memory channel 204. It is noted that system read requests (also called background read requests or non-host read requests) and system write requests are dispatched by a memory controller 202 to implement internal memory management functions including, but are not limited to, garbage collection, wear levelling, read disturb mitigation, memory snapshot capturing, memory mirroring, caching, and memory sparing.

In some embodiments, in addition to the channel controllers 214, the controller 202 further includes a local memory processor 218, a host interface controller 222, an SRAM buffer 224, and a DRAM controller 226. The local memory processor 218 accesses the plurality of memory channels 204 based on the one or more queues 216 of memory access requests. In some embodiments, the local memory processor 218 writes into and read from the plurality of memory channels 204 on a memory block basis. Data of one or more memory blocks are written into, or read from, the plurality of channels jointly. No data in the same memory block is written concurrently via more than one operation. Each memory block optionally corresponds to one or more memory pages. In an example, each memory block to be written or read jointly in the plurality of memory channels 204 has a size of 16 KB (e.g., one memory page). In another example, each memory block to be written or read jointly in the plurality of memory channels 204 has a size of 64 KB (e.g., four memory pages). In some embodiments, each page has 16 KB user data and 2 KB metadata. Additionally, a number of memory blocks to be accessed jointly and a size of each memory block are configurable for each of the system read, host read, system write, and host write operations.

In some embodiments, the local memory processor 218 stores data to be written into, or read from, each memory block in the plurality of memory channels 204 in an SRAM buffer 224 of the controller 202. Alternatively, in some embodiments, the local memory processor 218 stores data to be written into, or read from, each memory block in the plurality of memory channels 204 in a DRAM buffer 228A that is included in memory device 240, e.g., by way of the DRAM controller 226. Alternatively, in some embodiments, the local memory processor 218 stores data to be written into, or read from, each memory block in the plurality of memory channels 204 in a DRAM buffer 228B that is main memory used by the processor module 102 (FIG. 1). The local memory processor 218 of the controller 202 accesses the DRAM buffer 228B via the host interface controller 222.

In some embodiments, data in the plurality of memory channels 204 is grouped into coding blocks, and each coding block is called a codeword. For example, each codeword includes n bits among which k bits correspond to user data and (n-k) corresponds to integrity data of the user data, where k and n are positive integers. In some embodiments, the memory device 240 includes an integrity engine 230 (e.g., an LDPC engine) and registers 232, which include a plurality of registers or SRAM cells or flip-flops and are coupled to the integrity engine 230. The integrity engine 230 is coupled to the memory channels 204 via the channel controllers 214 and SRAM buffer 224. Specifically, in some embodiments, the integrity engine 250 has data path connections to the SRAM buffer 224, which is further connected to the channel controllers 214 via data paths that are controlled by the local memory processor 218. The integrity engine 230 is configured to verify data integrity and correct bit errors for each coding block of the memory channels 204.

In some embodiments, the memory system 200 includes an SSD having an L2P address indirection table 250 that stores physical addresses for a set of logical addresses, e.g., a logical block address (LBA). In some embodiments, the L2P address indirection table 250 is stored in an L2P table cache 212 included in the controller 202. Alternatively, in some embodiments, the memory system 200 includes a DRAM buffer 228A, and the L2P address indirection table 250 is stored in the DRAM buffer 228A. The local memory processor 218 of the controller 202 accesses the DRAM buffer 228A via a DRAM controller 226.

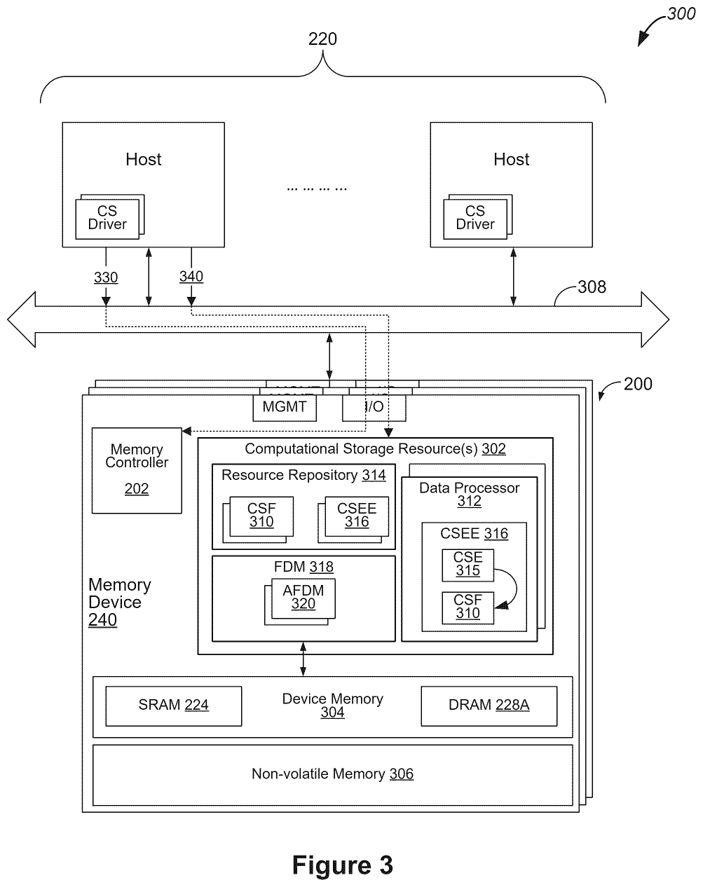

FIG. 3 is a block diagram of an example computer system 300 that includes a memory system 200 having an internal processing capability, in accordance with some embodiments. The memory system 200 is also called a computational storage device (CSD), and includes one or more memory devices 240 (e.g., SSDs). Each memory device 240 further includes a memory controller 202, a device memory 304, and a non-volatile memory 306 (e.g., memory channels 204). The host device(s) 220 and the one or more memory devices 240 of the memory system 200 are coupled to each other via a communication fabric 308. The communication fabric 308 includes a communication bus 140 (FIG. 1) that operates in compliance with a data bus standard, e.g., Peripheral Component Interconnect Express (PCIe), Ethernet standards. The host device(s) 220 are configured to issue memory access requests to write data into, and read data from, the non-volatile memory 306. The memory controller 202 accesses the non-volatile memory 306 in response to the memory access operations. Additionally, in some embodiments, the memory controller 202 dispatch system read requests (also called background read requests or non-host read requests) and system write requests to implement internal memory management functions including, but are not limited to, garbage collection, wear levelling, read disturb mitigation, memory snapshot capturing, memory mirroring, caching, and memory sparing. The device memory 304 of each memory device 240 further includes one or more of a L2P table cache 212, a SRAM buffer 224, and a DRAM buffer 228A, and is configured to store data temporarily while the memory controller 202 accesses the non-volatile memory 306 for memory accesses or internal memory management.

In some embodiments, the memory controller 202 is dedicated to processing the memory access requests and internal memory management functions. A memory device 240 further includes one or more computational storage resources (CSRs) 302 configured to implement data processing operations locally on the memory device 240. A set of predefined data processing operations are implemented to perform a computational storage function (CSF) 310, which is distinct from the memory access and internal memory management functions performed by the memory controller 202. In some embodiments, a computational storage resource 302 processes user data that are received from the host device(s) 220 or extracted from the non-volatile memory 306 during the data processing operations. In some embodiments, the processed data are stored into the non-volatile memory 306 or sent to the host device(s) 220 via the fabric 308. Further, in some embodiments, a subset of the user data, the process data, and intermediate data generated during the data processing operations is temporarily stored in the device memory 304 (e.g., SRAM buffer 224, DRAM buffer 228A).

In some embodiments, the computational storage resource 302 includes one or more data processors 312 and a resource repository 314. The one or more data processors 312 provide a computational storage engine configured to perform one or more predefined data processing operations, e.g., associated with a computational storage function 310 of the computational storage resource 302. In some embodiments, the computational storage function 310 corresponds to an in-memory application associated with the computational storage engine, and is implemented via the computational storage engine in the memory device 240. The resource repository 314 is a centralized location (e.g., memory space) storing various types of data and resources, such as software libraries, configuration files, media files, or any other type of data needed for a plurality of computational storage functions 310 performed by the computational storage resource 302. For example, the resource repository 314 stores instructions for creating a computational storage engine environment (CSEE) 316 and instructions for implementing a set of data processing operations associated with a computational storage function 310 in the CSEE 316. Instructions are loaded from the resource repository 314 and executed by the data processor 312, thereby creating the CSEE 316 where the computational storage engine 315 is executed to implement data processing operations associated with the computational storage function 310.

In some embodiments, the computational storage resource 302 further includes a function data memory (FDM) 318 for storing data that are used or generated by the computational storage engine 315 for performing a computational storage function 310. In some embodiments, the function data memory 318 is included in the device memory 304. For example, the function data memory 318 corresponds to a portion of the DRAM buffer 228A (FIG. 2). In another example, the function data memory 318 corresponds to a portion of the SRAM buffer 224 (FIG. 2). Further, in some embodiments, a portion of the function data memory 318 (also called an allocated FDM (AFDM) 320) is allocated for one or more instances of a computational storage function 310.

In some embodiments, a host device 22 issues a memory read or write request 330 to a memory device 240 of the memory system 200, and the memory controller 202 of the memory device 240 receives the memory read or write request 330 and accesses the non-volatile memory 306 accordingly. Alternatively, in some embodiments, a host device 22 issues a data processing request 340 to the memory device 240, and a data processor 312 of the computational storage resource 302 (e.g., the computational storage engine 315) receives the data processing request 340 and processes user data extracted from the data processing request or the non-volatile memory 306.

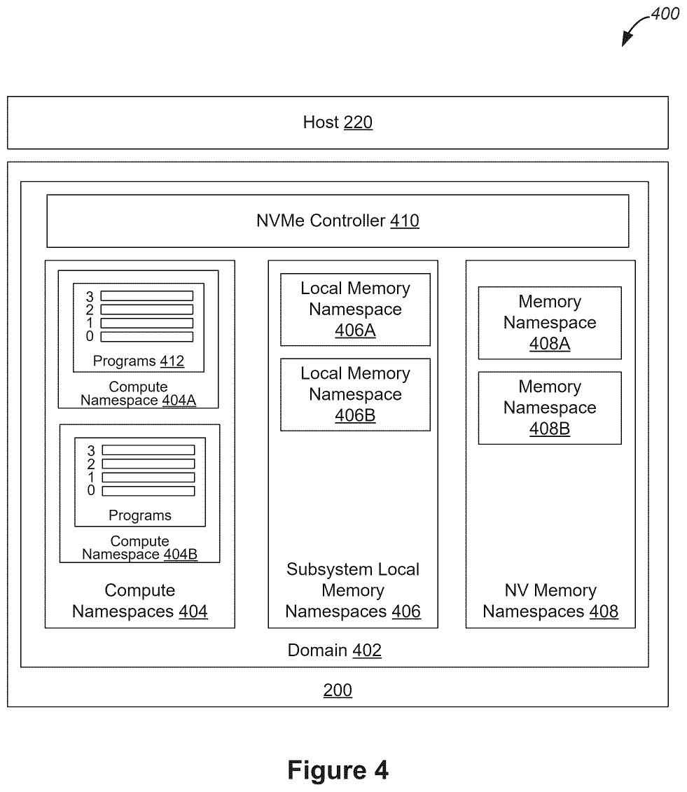

FIG. 4 is a block diagram of an example computer system 400 including a memory system 200 that operates in compliance with a storage access and transport protocol (e.g., nonvolatile memory express (NVMe)), in accordance with some embodiments. The memory system 200 includes one or more memory devices 240 each of which corresponds to a domain 402 according to the storage access and transport protocol. Each domain 402 corresponding to a respective memory device 240 includes a one or more compute namespace 404, local memory namespaces 406, memory namespaces 408, and a domain controller 410. Each namespace is a collection of LBAs accessible to, or associated with, a respective one of the plurality of programs.

A memory device 240 includes one or more processors having a computation capability (e.g., a memory controller 202, a data processor 312), a device memory 304 (e.g., a cache 212, a SRAM buffer 224, a DRAM buffer 228A), and a non-volatile memory 306. When the memory device 240 executes a plurality of programs, resources of the memory controller 202, the device memory 304, and the non-volatile memory 306 are allocated to implement the plurality of programs based on the storage access and transport protocol (e.g., NVMe). A plurality of compute namespaces 404 (e.g., 404A and 404B) correspond to, are configured to provide, instructions of the plurality of programs executed by the one or more programs of the memory device 240. Resources of the device memory 304 are allocated based on a plurality of local memory namespaces 406 (e.g., 406A and 406B) to facilitate execution of the plurality of programs by the memory device 240, so are resources of the non-volatile memory 306 allocated based on a plurality of memory namespaces 408 (e.g., 408A and 408B). It is noted that, in some embodiments, a number of programs is not limited to 2 and may be greater than 2, thereby creating more than two namespaces in each type of compute namespaces 404, 406, or 408.

In an example, a compute namespace 404A corresponds to a respective local memory namespace 406A and a respective non-volatile memory namespace 408A. The compute namespace 404A provides instructions of a corresponding program for execution by the one or more processors of the memory device 240. In some situations, input data that are processed, and output data that are generated, by these instructions are temporarily stored based on the local memory namespace 406A. In some situations, the input data are extracted based on the non-volatile memory namespace 408A, and the output data are stored based on the non-volatile memory namespace 408A. By these means, namespace allocation and utilization in the domain 402 corresponding to the memory device 240 are managed according to the storage access and transport protocol.

In some embodiments, the storage access and transport protocol includes a NVMe protocol for accessing flash storage (e.g., SSDs) via a PCI Express (PCIe) bus. The PCIe bus is configured to support a plurality of parallel command queues (e.g., on an order of 104 queues), thereby operating with a substantially high throughput and a substantially fast response time. In some embodiments, the host device 220 is configured to communicate and interact with each memory device 240 (e.g., SSD) as a standard NVMe storage device using the NVMe protocol. The host device 220 is configured to read and write data and implement data processing operations on the memory device 240 using NVMe commands.

In some embodiments, the host device 220 uses an operating system (e.g., a Linux operating system), and the CSRs 302 (FIG. 3) of the memory device 240 uses an embedded operating system (e.g., an embedded Linux operating system) that matches the operating system of the host device 220. In some embodiments, the host device 220 uses extended vendor unique commands to control and interact with the embedded operating system of the CSRs 302 of the memory device 240.

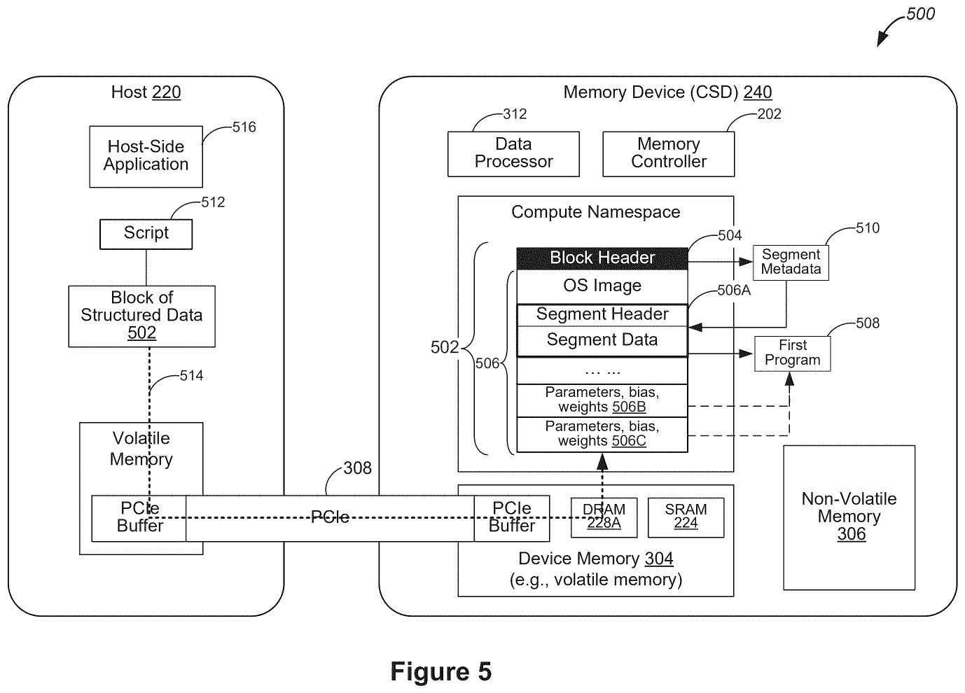

In some embodiments, an executable program 412 includes a body of bytes, and corresponds to one or more features in a compute namespace 404. A memory device 240 is reconfigured to a CSD to run the executable program 412. Further, in some embodiments, each of a plurality of programs 412 is loaded and installed onto the memory device 240 separately as a uniquely executable entity. In various embodiments of this application, a plurality of programs 412 are loaded onto the memory device 240 jointly in a block of structured data (e.g., 502 in FIG. 5).

FIG. 5 is a block diagram of an example computer system 500 that is loaded with a block of structured data 502, in accordance with some embodiments. The computer system 500 includes a host device 220 and one or more memory devices 240 (e.g., one or more SSDs). The memory device 240 includes a non-volatile memory 306 and a memory controller 202 that specializes in performing memory access functions and internal memory management functions. In some embodiments, the non-volatile memory 306 includes a solid-state drive (SSD) having a plurality of memory pages 210. In some embodiments, the memory device 240 is transformed to a CSD (FIG. 3) by incorporating at least one data processor 312 distinct from the memory controller 202. The data processor 312 is configured to process internal computational workloads (e.g., data processing operations) locally on the memory device 240.

In some embodiments, the memory device 240 obtains, from the host device 220, a block of structured data 502 having a block header 504 and one or more data segments 506 that include at least a first data segment 506A associated with a first program 508. The memory device 240 processes the block header 504 of the block of structured data 502 to determine segment metadata 510 of the first data segment 506A. The first data segment 506A is extracted from the block of structured data 502 based on the segment metadata 510. In some embodiments, the segment metadata 510 of the first data segment 506A includes a size and a location of the first data segment 506A, and the first data segment 506A is extracted from the block of structured data 502 based on the size and the location of the first data segment 506A. Further, the first program 508 is executed based on the first data segment 506A. In some embodiments, the first data segment 506A includes program codes of the first program 508. Alternatively, in some embodiments, the first data segment 506A does not include program codes of the first program 580, and includes data (e.g., input data, parameters, metadata, program configurations and settings, neural network weights and biases) used by the first program 580.

In some embodiments, the block header 504 is a computational program conditional header that is located is at a predefined location (e.g., a beginning, an end) of the block of structured data 502. The block header 504 introduce data fields and bytes dynamically within an initial sequence of bytes of the block of structured data 502. The block header 504 acts as a table of content of, and provides a summary of, the one or more data segments 506. In some embodiments, the block header 504 indicates the nature or functions of a body of bytes corresponding to each data segment 506 (e.g., which includes a respective program 412 (FIG. 4) or associated data). Each program 412 represents any number of computational storage functions. The block header 504 dictates whether the body of bytes includes an executable program, identifies a target processor unit, or defines a sequence of events that the CSD (e.g., the memory device 240) executes. In some embodiments, the block header 504 indicates hardware, functions, parameters, and orchestration that the CSD (e.g., the memory device 240) uses to implement each program 412 associated with one or more respective data segments 506. As such, the block header 504 allows a plurality of programs 412 (FIG. 4) or associated data to be loaded concurrently in the block of structured data 502, thereby improving flexibility of computational storage without being limited by individual program loading requirements under the NVMe.

In some embodiments, the host device 220 obtains a script 512 of the block of structured data 502 that includes the block header 504. The block of structured data 502 is generated according to the script 512. The block header 504 of the block of structured data 502 includes a plurality of data fields that are organized according to the script 512, and the segment metadata 510 of the first data segment 506A corresponds to a subset of data fields. In some embodiments, the memory device 240 further includes a volatile memory 304 (e.g., NAND flash memory). The memory controller 202 receives (operation 514) the block of structured data 502 from the host device 220 by way of a communication fabric 308, and stores the block of structured data 502 in the volatile memory 304 (e.g., DRAM buffer 228A). The data processor 312 extracts a subset of the block of structured data 502 from the volatile memory 304. The first program 508 is loaded in the data processor 312 via based on the extracted subset of the block of structured data 502. In some embodiments, the data processor 312 stores at least part of the first data segment 506A into the volatile memory 304 (e.g., DRAM buffer 228A), and the memory controller 202 obtains the part of the first data segment 506A from the volatile memory 304 and stores the part of the first data segment 506A into the non-volatile memory 306.

In some embodiments, based on the segment metadata 510 of the first data segment 506A, the memory device 240 determines that the first data segment 506A includes executable codes of the first program 508. In some embodiments, based on the segment metadata 510 of the first data segment 506A, the memory device 240 identifies one of the data processor 312 and the memory controller 202 as an executing entity. In some embodiments, based on the segment metadata 510 of the first data segment 506A, the memory device 240 identifies a sequence of operations to be performed based on the first program 508. The segment metadata 510 includes one or more of: a hardware requirement, a function, precursor initialization, parameter settings, resource allocation, and orchestration of the sequence of operations.

In some situations, the first data segment 506A includes an executable image of the first program 508. In accordance with the executable image, the data processor 312 executes the first program 508. An executable image of the first program 508 is the first program 508 captured in a state that is executable. In some embodiments, the executable image is a frozen image, just an image, a still, of the first program 508 on disk that can be loaded as is and control can be passed to the executable image, brought to life from that point on. An executable image implies that it's not only an image as in a snapshot of the program state but one that is ready to be executed and control can be passed to it and it can correctly operate. Conversely, in some embodiments, a state of the first program 508 halfway through execution is not an executable image because data sections will have changed to values that will cause false behavior if control is passed to the entry point.

Alternatively, in some situations, the first data segment 506A includes codes of the first program 508, which are stored (e.g., by the memory controller 202) into the non-volatile memory 306. The data processor 312 loads the codes of the first program 508 from the non-volatile memory 306 and executes the first program 508. Alternatively, in some situations, the first data segment 506A includes data to be used by the first program 508. The data is stored (e.g., by the memory controller 202) to, and extracted from, the non-volatile memory 306. The data is further stored in a buffer (e.g., the DRAM buffer 228A). The first program 508 is executed to process the data. Alternatively, in some situations, the first data segment 506A includes weights and biases of a machine learning model (e.g., a neural network) to be used by the first program 508. The memory controller 202 stores the weights and biases of the machine learning model to the non-volatile memory 306. The memory controller 202 extracts the weights and biases from the non-volatile memory 306, and stores the weights and biases in a buffer (e.g., DRAM buffer 228A). In accordance with a determination that an execution condition of the first program 508 is satisfied, the first program 508 is executed (e.g., by the data processor 312) to apply the machine learning model to process the data stored in the non-volatile memory 306. For example, the execution condition includes one or more of: an execution frequency, an execution schedule, and an execution trigger data volume.

In some embodiments, after loading the block of structured data 502 to the CSD (e.g., the memory device 240), the host device 220 runs a host-side application 516 that is configured to trigger different segments 506 of the block of structured data 502 (e.g., periodically). For example, in some situations, execution of the first program 508 involves multiple data segments 506 including the first data segment 506A. The host-side application 516 issues a trigger or a command to cause the memory device 240 to extract the first program 508 and associated metadata, parameters, or values from different segments 506 of the block of structured data 502 and combine them for the purposes of executing the first program 508. In an example, the host-side application 516 sends an instruction to the memory device 240 to execute the first program 508, which corresponds to program codes located in the first data segment 506A of the block of structured data 502 using parameters loaded in a second data segment 506B of the block of structured data 502, where machine learning parameters and weights are included. The second data segment 506B is selected based on a current host workload. In some situations, the host workload continues to change and have an updated host workload. Based on the updated host workload, the host-side application 516 sends another instruction to the memory device 240, requesting the first program 508 to be executed using machine learning parameters and weights that are loaded in a third data segment 506C of the block of structured data 502. Additionally, in some embodiments, a temperature changes or a power requirement change may be associated with a host-side trigger and cause the first program 508 to be executed based on different data segments 506 of the block of structured data 502.

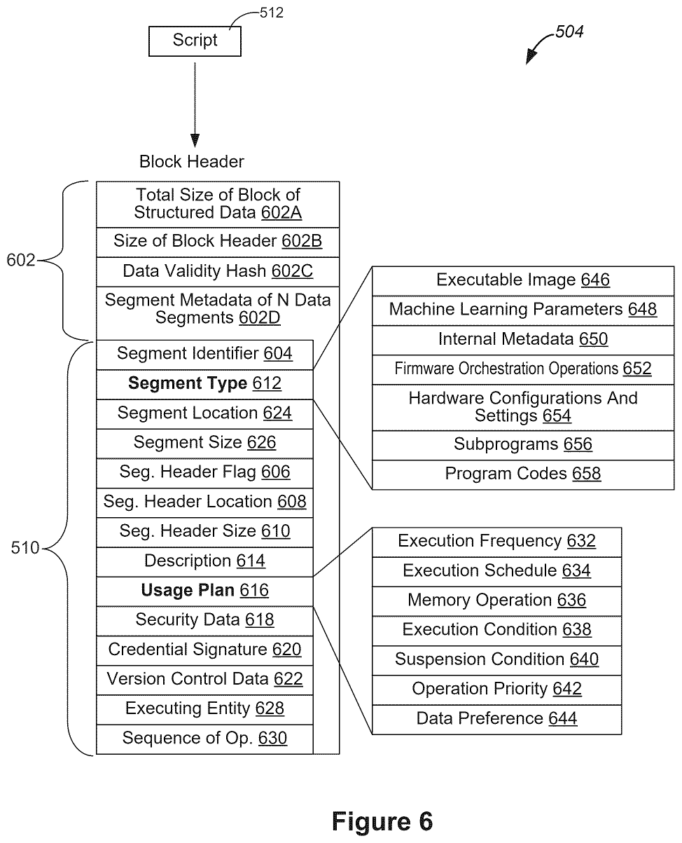

FIG. 6 is a structural diagram of an example block header 504 of a block of structured data 502 loaded in an electronic device (e.g., a memory device 240), in accordance with some embodiments. A memory device 240 obtains a block of structured data 502 having a block header 504 and one or more data segments 506. The one or more data segments 506 include at least a first data segment 506A associated with a first program 508 (FIG. 5). The memory device 240 processes the block header 504 of the block of structured data 502 to determine segment metadata 510 of the first data segment 506A. The first data segment 506A is extracted from the block of structured data 502 based on the segment metadata 510. The first program 508 is executed based on the first data segment 506A. In some embodiments, the block header 504 acts as a table of content of, and provides a summary of, the one or more data segments 506 of the block of structured data 502.

In some embodiments, the block of structured data 502 obtained by the memory device 240 is generated by the host device 220 according to a script 512 and provided to the memory device 240. Alternatively, in some embodiments, the block of structured data 502 is preloaded in, and may be extracted by a memory controller 202 from, memory cells of the memory device 240. Additionally and alternatively, in some embodiments, the block of structured data 502 obtained by the memory device 240 includes a first set of segments that are generated and provided by the host device 220 and a second set of segments that are preloaded to, and retrieved from, the memory cells of the memory device 240. For example, the second set of segments include generic programs having a relatively small size and stored on NAND cells locally on the memory device 240. The host device 220 provides the memory device 240 with the first set of segments including a data body. The data body further includes instructions to fetch, and incorporate into the data body, the generic programs to be retrieved from the NAND cells. Further, in some embodiments, the block header 504 (e.g., a table of content) is updated to include segments 506 corresponding to the generic programs that are retrieved from the NAND cells.

In some embodiments, the block header 504 includes a plurality of data fields 602, and the plurality of data fields 602 include one or more of: a total size 602A of the block of structured data 502, a size 602B of the block header 504, a data validity hash 602C, and segment metadata 602D of the one or more data segments 506. In some embodiments, the data validity hash 602C is associated with a hash function configured to verify data integrity by creating a digital fingerprint of the data associated with a respective data segment 506. The hash function is used to determine a block hash of the block of structured data 502. The block hash is compared with the data validity hash 602C to determine whether the block of structured 502 has not been altered or corrupted during transmission. An example of the data validity hash 602C includes a cyclic redundancy check (CRC) hash.

The segment metadata 602D includes the segment metadata 510 of the first data segment 506A. In some embodiments, for each data segment 506, the segment metadata 602D includes one or more of: a segment identifier 604, a segment header flag 606 indicating whether the respective data segment 506 includes a respective segment header, a location 608 and a size 610 of the respective segment header, a segment type 612, description 614, a usage plan 616, security data 618, a credential signature 620, and version control data 622 of the respective data segment 506. In some embodiments, for each data segment 506, the segment metadata 602D includes one or more of: a segment location 624, a segment size 626, an executing entity 628, and a sequence of operations 630 associated with the respective data segment 506. In an example, based on the segment metadata 510 of the first data segment 506A, the memory device 240 identifies one of the data processor 312 and the memory controller 202 based on the executing entity 628. In some embodiments, based on the segment metadata 510 of the first data segment 506A, the memory device 240 identifies the sequence of operations 630 to be performed based on the first program 508.

In some embodiments, the segment metadata 510 of the first data segment 506A includes a usage plan 616 of the first data segment 506A. The usage plan 616 includes one or more of: an execution frequency 632, an execution schedule 634, a predefined memory operation 636, an execution condition 638, a suspension condition 640, an operation priority 642, and a data preference 644 for the first program 508. Based on the usage plan 616, the first program 508 is executed by the data processor 312 based on the first data segment 506A. Further, in some situations, execution of the first program 508 involves multiple data segments 506 including the first data segment 506A. The first program 508 and associated metadata, parameters, or values are extracted from different segments 506 of the block of structured data 502, and combined for executing the first program 508. In an example, program codes of the first program 508 are located in the first data segment 506A of the block of structured data 502, and executed based on parameters loaded in a second data segment 506B (FIG. 5) of the block of structured data 502, where machine learning parameters and weights are included. The second data segment 506B is selected based on a current host workload. In some situations, the host workload is updated, and the first program 508 is executed using machine learning parameters and weights that are loaded in a third data segment 506C (FIG. 5) of the block of structured data 502. In some embodiments, the data processor 312 executes the first program 508 automatically based on the usage plans 616 of the data segments 506A, 506B, and 506C. Alternatively, in some embodiments, the host device 220 sends commands to control execution of the first program 508 based on the usage plans 616 of the data segments 506A, 506B, and 506C.

In some embodiments, for each data segment 506 (e.g., the first data segment 506A), the segment type 612 is one of an executable image 646, machine learning parameters 648 (e.g., weights and biases), internal metadata 650, firmware orchestration operations 652, hardware configurations and settings 654, subprograms 656, and program codes 658 associated with a respective program. For example, in some situations, the first data segment 506A includes an executable image 646 of the first program 508. In accordance with the executable image 646, the data processor 312 executes the first program 508. Alternatively, in some situations, the first data segment 506A includes codes of the first program 508, which are stored (e.g., by the memory controller 202) into the non-volatile memory 306. The data processor 312 loads the codes of the first program 508 from the non-volatile memory 306 and executes the first program 508. Alternatively, in some situations, the first data segment 506A includes data to be used by the first program 508. The data is stored (e.g., by the memory controller 202) to, and extracted from, the non-volatile memory 306. The data is further stored in a buffer (e.g., the DRAM buffer 228A). The first program 508 is executed to process the data. Alternatively, in some situations, the first data segment 506A includes machine learning parameters 648 (e.g., weights and biases of a machine learning model) to be used by the first program 508. The memory controller 202 stores the weights and biases of the machine learning model to the non-volatile memory 306. The memory controller 202 extracts the weights and biases from the non-volatile memory 306, and stores the weights and biases in a buffer (e.g., DRAM buffer 228A). In accordance with a determination that an execution condition of the first program 508 is satisfied, the first program 508 is executed (e.g., by the data processor 312) to apply the machine learning model to process the weights and biases stored in the non-volatile memory 306. For example, the execution condition includes one or more of: an execution frequency, an execution schedule, and an execution trigger data volume.

In some embodiments, the block header 504 includes an ordered sequence of data fields 602 (e.g., which includes data bytes 602-658 in FIG. 6), and these data fields 602 are ordered based on an agreement between the host device 220 and the memory device 240. The block header 504 is dictated with a proprietary format of the CSD, including security measures (e.g., security data 618) and locations of bytes related to security. In some embodiments, a host-side application 516 (FIG. 5) is executed to receive a first user input identifying a plurality of data segments 506 to be included in the block of structured data 502. The plurality of data segments 506 correspond to one or more programs that are executable on the memory device 240. In some embodiments, the host-side application 516 is executed to receive a second user input identifying or organizing different data fields associated with segment metadata 602D of each data segment 506. Further, in some embodiments, the script 512 is created, e.g., based on a device agreement, the first user input, or the second user input, and used to organize data fields within the block header 504 and associated data segments 506. In an example, a subset of data segments 506 correspond to a singularly stitched image including a plurality of portions of the image that are loaded via distinct data segments. For each of the subset of data segments 506, the block header 504 includes a respective segment header flag 606 indicating that the respective data segment 506 has a respective segment header, a segment header location 608 identifying a location of the respective segment header in the respective data segment, and a respective segment header size 610 indicating a size of the respective segment header.

Examples of data fields in the block header 504 include, but are not limited to, total byte size, total header size, a CRC hash for data integrity and security, table of contents bytes, detailing index of segments, segment info, whether it contains a segment header, a segment header location and size within segment, segment type, descriptor bytes, opcodes, security bytes, corporate signature bytes, and version control bytes. An opcode is abbreviated from operation code (also known as instruction machine code, instruction code, instruction syllable, instruction parcel or opstring) is a portion of a machine language instruction that specifies an operation to be performed by the data processor 312.

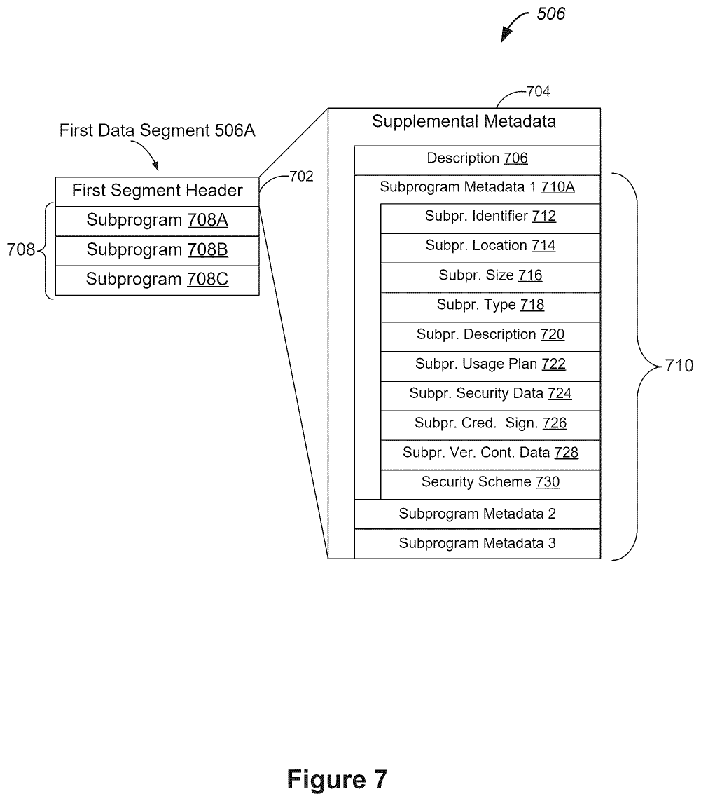

FIG. 7 is a structural diagram of an example data segment 506 (e.g., the first data segment 506A in FIG. 5) in a block of structural data 502 loaded in an electronic device (e.g., a memory device 240), in accordance with some embodiments. A memory device 240 obtains a block of structured data 502 having a block header 504 and one or more data segments 506. The one or more data segments 506 include at least a first data segment 506A associated with a first program 508 (FIG. 5). The memory device 240 processes the block header 504 of the block of structured data 502 to determine segment metadata 510 of the first data segment 506A. The first data segment 506A is extracted from the block of structured data 502 based on the segment metadata 510. The first program 508 is executed based on the first data segment 506A. In some embodiments, the block of structured data 502 includes a single data segment 506. Alternatively, in some embodiments, the block of structured data 502 includes a plurality of data segments 506. Further, in some embodiments, the first program 508 is executed based on a set of two or more data segments 506 including the first data segment 506A.

In some embodiments, the first data segment 506A includes a first segment header 702 configured to provide supplemental metadata 704 of the first data segment 506A in addition to the segment metadata 510 of the first data segment 506A included in the block header 504 (FIG. 5). Supplemental metadata 704 are also called local segmental metadata. In an example, the supplemental metadata 704 include description 706 of the first data segment 506A. Further, in some embodiments, the first data segment 506A further includes a plurality of subprograms 708 (e.g., including subprograms 708A, 708B, and 708C) of the first program 508, and the first segment header 702 further includes subprogram metadata 710 of each of the plurality of subprograms 708. The subprogram metadata 710 of each subprogram 708 (e.g., subprogram metadata 710A for a first subprogram 708A) includes one or more of: a subprogram identifier 712, a location 714, a size 716, a type 718, description 720, a usage plan 722, a security scheme 724, a credential signature 726, and version control data 728 of the respective subprogram 708. Additionally, in some embodiments, when the first program 508 is executed based on the first data segment 506A, one or more subprograms of the plurality of subprograms 708 are selected and executed, e.g., by the data processor 312 or the memory controller 202.

In some embodiments not shown, a data segment 506 includes a contiguous group of data bytes. Examples of the data segment 506 include, but are not limited to, executable images, artificial intelligence and machine learning parameters (e.g., weights and biases), internal tables or metadata, firmware orchestration steps or sequences, hardware engine configurations and settings, memory configuration values and settings, computational storage configuration values and settings, and subprograms 708. A corresponding segment type 612 is included in the segment metadata 510 in the block header 504 (FIG. 6). Further, in some embodiments, each of a subset of subprogram 708 has a respective subprogram header and security scheme.

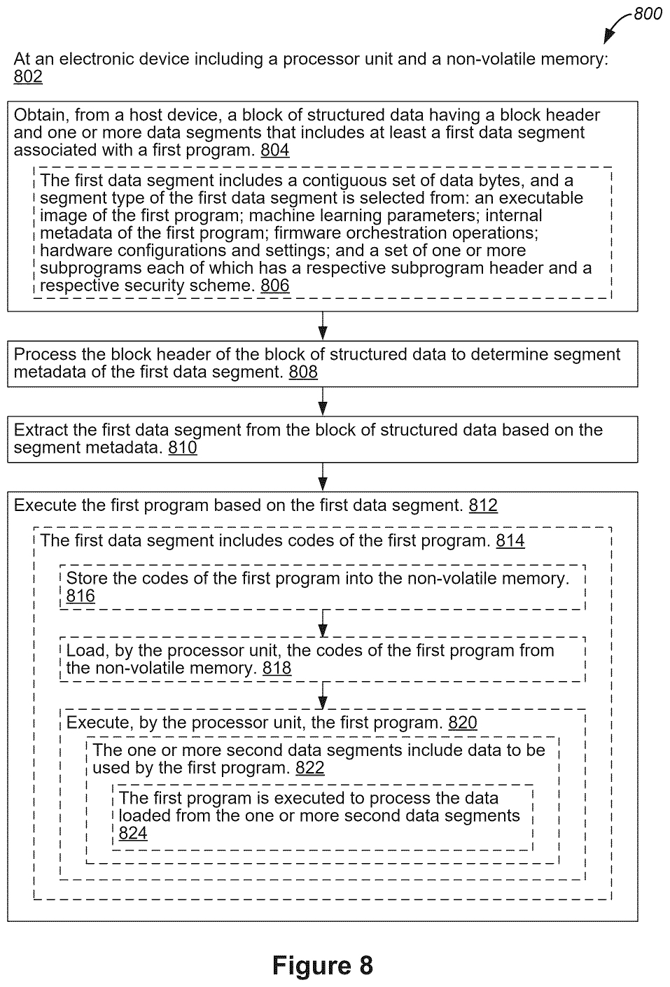

FIG. 8 is a flow diagram of an example method 800 for managing a data structure, in accordance with some embodiments. The method 800 is implemented at a memory device 240 (FIGS. 2 and 3) to manage a data structure in support of data processing in the memory device 240. The method 800 is implemented (operation 802) at an electronic device (e.g., a memory device 240, a memory system 200) including a processor unit (e.g., a data processor 312 and/or a memory controller 202) and a non-volatile memory 306. The electronic device obtains (operation 804), e.g., from a host device 220 or from memory channels 204, a block of structured data 502 having a block header 504 and one or more data segments 506. The one or more data segments 506 include at least a first data segment 506A associated with a first program 508. The block header 504 of the block of structured data 502 is processed (operation 808) to determine segment metadata 510 of the first data segment 506A. The first data segment 506A is extracted (operation 810) from the block of structured data 502 based on the segment metadata 510. The electronic device executes (operation 812) the first program 508 based on the first data segment 506A.

In some embodiments, a host device 220 obtains a script 512 of the block of structured data 502, and generates the block of structured data 502 according to the script 512. The block header 504 includes a plurality of data fields (e.g., data bytes) that are organized according to the script 512, and the segment metadata 510 of the first data segment 506A corresponds to a subset of data fields.

In some embodiments, the block header 504 includes a plurality of data fields, and the plurality of data fields include one or more of: a total size 602A of the block of structured data 502, a size 602B of the block header 504, a data validity hash 602C, and segment metadata 602D of the one or more data segments 506 (FIG. 6). The segment metadata 602D of each data segment 506 (e.g., the segment metadata 510 of the first data segment 506A) includes one or more of: a segment identifier 604, a segment header flag 606 indicating whether the respective data segment (e.g., the first data segment 506A) includes a respective segment header (e.g., header 702 in FIG. 7), a location 608 and a size 610 of the respective segment header, a segment type 612, description 614, a usage plan 616, security data 618, a credential signature 620, and version control data 622 of the respective data segment 506 (FIG. 6).

In some embodiments (FIG. 6), the first data segment 506A includes (operation 806) a contiguous set of data bytes, and a segment type 612 of the first data segment 506A is selected from an executable image 646 of the first program 508, machine learning parameters 648, internal metadata 650 of the first program 508, firmware orchestration operations, hardware configurations and settings 654, and a set of one or more subprograms 656, each of which has a respective subprogram header and a respective security scheme.

In some embodiments, the segment metadata 510 of the first data segment 506A includes a usage plan 616 of the first data segment 506A (FIG. 6). The usage plan 616 includes one or more of: an execution frequency 632, an execution schedule 634, a predefined memory operation 636, an execution condition 638, a suspension condition 640, an operation priority 642, and a data preference 644 for the first program 508 (FIG. 6). Based on the usage plan 616, the first program 508 is executed by the processor unit based on the first data segment 506A.

In some embodiments, based on the segment metadata 510 of the first data segment 506A, the electronic device determines that the first data segment 506A includes executable codes of the first program 508, identifies one of the processor unit (e.g., a data processor 312) and a memory controller 202 as an executing entity 628, and identifies a sequence of operations 630 (FIG. 6) to be performed based on the first program 508. The segment metadata 510 includes one or more of: a hardware requirement, a function, precursor initialization, parameter settings, resource allocation, and orchestration of the sequence of operations 630.

In some embodiments, the segment metadata 510 of the first data segment 506A includes a size 626 and a location 624 of the first data segment 506A, and the first data segment 506A is extracted from the block of structured data 502 based on the size 626 and the location 624 of the first data segment 506A.

In some embodiments, the first data segment 506A includes an executable image of the first program 508. In accordance with the executable image, the processor unit executes the first program 508.

In some embodiments, the first data segment 506A includes (operation 814) codes of the first program 508. The electronic device (e.g., the memory controller 202) stores (operation 816) the codes of the first program 508 into the non-volatile memory 306. The data processor 312 loads (operation 818) the codes of the first program 508 from the non-volatile memory 306 and executes (operation 820) the first program 508. Further, in some embodiments, one or more alternative data segments 506 (e.g., data segments 506 506B and 506C) include data to be used by the first program 508. The memory controller 202 stores (operation 822) the data of the one or more alternative data segments 506 to the non-volatile memory 306, extracts the data from the non-volatile memory 306, and stores the data in a buffer (e.g., DRAM buffer 228A, SRAM buffer 224 in FIG. 2). The first program 508 is executed (operation 824) to process the data loaded from the one or more alternative data segments 506.

In some embodiments, the first data segment 506A includes data to be used by the first program 508. The memory controller 202 stores the data to the non-volatile memory 306, extracts the data from the non-volatile memory 306, and stores the data in a buffer (e.g., DRAM buffer 228A). The first program 508 is executed to process the data. The first program 508 is executed by the memory controller 202 or the data processor 312 based on a function associated with the first program 508. The data processor is configured to process internal computational workloads (e.g., the data processing operations) locally on the memory device 240, while the memory controller 202 of the memory device 240 specializes in performing memory access functions and internal memory management functions.

In some embodiments, the first data segment 506A includes weights and biases of a machine learning model to be used by the first program 508. The memory controller 202 stores the weights and biases of the machine learning model to the non-volatile memory 306, extracts the weights and biases from the non-volatile memory 306, and stores the weights and biases in a buffer (e.g., DRAM buffer 228A). In accordance with a determination that data stored in an execution condition of the first program 508 is satisfied, the first program 508 is executed by the data processor 312 to apply the machine learning model to process the weights and biases of the machine learning model stored in the non-volatile memory 306.

In some embodiments, the first data segment 506A includes a first segment header 702 configured to provide supplemental metadata of the first data segment 506A in addition to the segment metadata 510 of the first data segment 506A included in the block header 504. Further, in some embodiments, the first data segment 506A further includes a plurality of subprograms 708 of the first program 508, and the first segment header 702 further includes subprogram metadata 710 of each of the plurality of subprograms 708. The subprogram metadata 710A of each subprogram 708 includes one or more of: a subprogram identifier 712, a location 714, a size 716, a type 718, description 720, a usage plan 722, a security scheme 730, a credential signature 726, and version control data 728 of the respective subprogram 708. Additionally, in some embodiments, the electronic device executes the first program 508 based on the first data segment 506A by selecting one or more subprograms 708 of the plurality of subprograms 708 and executing the one or more subprograms 708.

In some embodiments, the electronic device includes a volatile memory (e.g., DRAM buffer 228A) and a memory controller 202 distinct from the processor unit (e.g., a data processor 312). The electronic device obtains the block of structured data 502 from the host device 220. The memory controller 202 receives the block of structured data 502 from the host device 220, and stores the block of structured data 502 in the volatile memory. The data processor 312 extracts the block of structured data 502 from the volatile memory.

In some embodiments, the electronic device includes a volatile memory (e.g., DRAM buffer 228A) and a memory controller 202 distinct from the processor unit (e.g., a data processor 312). The data processor stores at least part of the first data segment 506A into the volatile memory. The memory controller 202 extracts the part of the first data segment 506A stored into the volatile memory, and stores the at least part of the first data segment 506A into the non-volatile memory 306.

In some embodiments, the non-volatile memory 306 includes a solid-state drive (SSD) having a plurality of memory pages 210. In some embodiments, the block of structured data 502 is started with the block header 504.

In accordance with at least some embodiments disclosed herein is the realization that an executable program includes a body of bytes and is loaded separately according to existing CSD and NVMe specifications. The method 800 is directed to loading a block of structured data 502 including a configurable block header 504 that the memory device 104 is configured to decode and process. The block of structured data 502 is applied to load a plurality of data segments 602 including one or more programs and/or one or more different program-related data items jointly. In some embodiments, a computational program header (e.g., a block header 504) is used in computational storage devices (e.g., memory devices 240 supplemented with data processing capabilities). The computational program header includes dynamically configurable data fields in an initial sequence of bytes, which dictates nature and functionality of the program body (e.g., the first program 508 in FIG. 5). In some embodiments, the block header 504 or associated bytes may indicate whether the program body is an executable program and specifies the executing entity 628 (FIG. 6). In some embodiments, the block header 504 or associated bytes may detail a sequence of operations 630 for the CSD 240 to perform, including hardware requirements, functions, parameters, and orchestration. In some embodiments, the block header 504 or associated bytes may segment the program body into subprograms 656, each with a respective header 702 (FIG. 7).

Some implementations of this application are directed to a method for computational storage. A dynamic program header (e.g., a block header 504) is used to indicate diverse functionalities and meanings of a program body (e.g., data segments 506), thereby facilitating to computational storage operations in a flexible and customizable manner. In some embodiments, the block header 504 identifies a program body (e.g., data segments 506) as an executable image 646, sets the executing entity 628, and initializes precursors and parameters. In some embodiments, the block header 504 defines specifications of a series of operations 630 (FIG. 6), including but not limited to, hardware engagement, functional executions, parameter settings, and orchestration of processes within the CSD 240.

In some embodiments, a computational storage system includes a CSD 240 equipped with firmware configured to interpret and process a dynamic program header (e.g., a block header 504), facilitating execution and management of computational storage tasks in a flexible and adaptable manner. In some embodiments, the block header 504 enables the CSD to execute a range of functions beyond traditional executable programs, including customized operations as dictated by header configurations (e.g., stored in data fields 602A-602C). In some embodiments, the block header 504 enables the CSD to customize security and correctness of the executable image (program body) and segments within the executable image (program body). In some embodiments, the block header 504 enables the CSD to orchestrate a combination of custom operations and embedded subprograms 708, thereby implementing a NVMe program (e.g., the first program 508 in FIG. 7). In some embodiments, the block header 504 enables the CSD to selectively execute subprograms 708 within the data segments 506 of the block of structured data 502, by providing header bytes (e.g., segment header 702) which identify and index the internal subprograms 708. In some embodiments, the block header 504 enables the CSD to provide flexibility for customized security features and future proof adaptability.

Memory is also used to store instructions and data associated with the method 800, and includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing method 800.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A method for processing data, comprising:
at an electronic device including a processor unit and a non-volatile memory:
obtaining a block of structured data having a block header and one or more data segments that includes at least a first data segment associated with a first program;
processing the block header of the block of structured data to determine segment metadata of the first data segment;
extracting the first data segment from the block of structured data based on the segment metadata; and
executing the first program based on the first data segment.

2. The method of claim 1, further comprising, at a host device:
obtaining a script of the block of structured data; and
generating the block of structured data according to the script, wherein the block header includes a plurality of data fields that are organized according to the script, and the segment metadata of the first data segment corresponds to a subset of data fields.

3. The method of claim 1, wherein the block header includes a plurality of data fields, and the plurality of data fields include one or more of:
a total size of the block of structured data;
a size of the block header;
a data validity hash; and
segment metadata of the one or more data segments, the segment metadata of each data segment including one or more of: a segment identifier, a segment header flag indicating whether the respective data segment includes a respective segment header, a location and a size of the respective segment header, a segment type, description, a usage plan, security data, a credential signature, and version control data of the respective data segment.

4. The method of claim 1, wherein the first data segment includes a contiguous set of data bytes, and a segment type of the first data segment is selected from:
an executable image of the first program;
machine learning parameters;
internal metadata of the first program;
firmware orchestration operations;
hardware configurations and settings; and
a set of one or more subprograms each of which has a respective subprogram header and a respective security scheme.

5. The method of claim 1, wherein:
the segment metadata of the first data segment includes a usage plan of the first data segment;
the usage plan includes one or more of: an execution frequency, an execution schedule, a predefined memory operation, an execution condition, a suspension condition, an operation priority, and a data preference for the first program; and
based on the usage plan, the first program is executed by the processor unit based on the first data segment.

6. The method of claim 1, further comprising, based on the segment metadata of the first data segment, implementing one or more of:
determining that the first data segment includes executable codes of the first program;
identifying one of the processor unit and a memory controller as an executing entity; and
identifying a sequence of operations to be performed based on the first program, the segment metadata including one or more of: a hardware requirement, a function, precursor initialization, parameter settings, resource allocation, and orchestration of the sequence of operations.

7. The method of claim 1, wherein the segment metadata of the first data segment includes a size and a location of the first data segment, and the first data segment is extracted from the block of structured data based on the size and the location of the first data segment.

8. The method of claim 1, wherein the first data segment includes an executable image of the first program, the method further comprising:
in accordance with the executable image, executing the first program by the processor unit.

9. The method of claim 1, wherein the first data segment includes codes of the first program, the method further comprising:
storing the codes of the first program into the non-volatile memory;
loading, by the processor unit, the codes of the first program from the non-volatile memory; and
executing, by the processor unit, the first program.

10. The method of claim 9, wherein one or more alternative data segments include data to be used by the first program, the method further comprising:
storing the data of the one or more alternative data segments to the non-volatile memory;
extracting the data from the non-volatile memory;
storing the data in a buffer, wherein the first program is executed to process the data loaded from the one or more alternative data segments.

11. The method of claim 1, wherein the first data segment includes data to be used by the first program, the method further comprising:
storing the data to the non-volatile memory;
extracting the data from the non-volatile memory;
storing the data in a buffer, wherein the first program is executed to process the data.

12. The method of claim 1, wherein the first data segment includes weights and biases of a machine learning model to be used by the first program, the method further comprising:
storing the weights and biases of the machine learning model to the non-volatile memory;
extracting the weights and biases from the non-volatile memory; and
storing the weights and biases in a buffer, wherein in accordance with a determination that an execution condition of the first program is satisfied, the first program is executed to apply the machine learning model to process the weights and biases stored in the non-volatile memory.

13. The method of claim 1, wherein the first data segment includes a first segment header configured to provide supplemental metadata of the first data segment in addition to the segment metadata of the first data segment included in the block header.

14. The method of claim 13, wherein the first data segment further includes a plurality of subprograms of the first program, and the first segment header further includes subprogram metadata of each of the plurality of subprograms, and wherein the subprogram metadata of each subprogram includes one or more of: a subprogram identifier, a location, a size, a type, description, a usage plan, a security scheme, a credential signature, and version control data of the respective subprogram.

15. The method of claim 14, wherein executing the first program based on the first data segment further comprises:
selecting one or more subprograms of the plurality of subprograms; and
executing the one or more subprograms.

16. The method of claim 1, wherein the electronic device includes a volatile memory and a memory controller distinct from the processor unit, and obtaining the block of structured data from the host device further comprises:
receiving, by the memory controller, the block of structured data from the host device;
storing, by the memory controller, the block of structured data in the volatile memory; and
extracting, by the processor unit, the block of structured data from the volatile memory.

17. The method of claim 1, wherein the non-volatile memory includes a solid-state drive (SSD) having a plurality of memory pages.

18. The method of claim 1, wherein the block of structured data is started with the block header.

19. An electronic device, comprising:
a non-volatile memory; and
one or more processors coupled to the non-volatile memory, wherein the processor unit is configured for:
obtaining a block of structured data having a block header and one or more data segments that includes at least a first data segment associated with a first program;
processing the block header of the block of structured data to determine segment metadata of the first data segment;
extracting the first data segment from the block of structured data based on the segment metadata; and
executing the first program based on the first data segment.

20. A non-transitory computer-readable storage medium storing one or more programs for execution by one or more processors of an electronic device, the one or more programs comprising instructions for:
obtaining a block of structured data having a block header and one or more data segments that includes at least a first data segment associated with a first program;
processing the block header of the block of structured data to determine segment metadata of the first data segment;
extracting the first data segment from the block of structured data based on the segment metadata; and
executing the first program based on the first data segment
